(19) United States
(12) Patent Application Publication
(10) Pub. No.: US 2017/0178346 A1
(43) Pub. Date: Jun. 22, 2017

(54) NEURAL NETWORK ARCHITECTURE FOR ANALYZING VIDEO DATA

(71) Applicant: HIGH SCHOOL CUBE, LLC, San Francisco, CA (US)

(72) Inventors: Michael W. Ferro, Chicago, IL (US); Mark Woodward, Las Vegas, NV (US)

(21) Appl. No.: 15/382,438

(22) Filed: Dec. 16, 2016

Related U.S. Application Data
(60) Provisional application No. 62/268,279, filed on Dec. 16, 2015.

(51) Int. Cl. G06T 7/246; G06N 3/04; G06N 3/08

(52) U.S. Cl. CPC G06T 7/246; G06N 3/08; G06N 3/04; G06T 2207/10016; G06T 2207/20084

(57) ABSTRACT

Embodiments are provided for analyzing and characterizing video data. According to certain aspects, an analysis machine may analyze video data and optional audio data corresponding thereto using one or more artificial neural networks (ANNs). The analysis machine may process an output of this analysis with a recurrent neural network and an additional ANN. The output of the additional ANN may include a prediction vector comprising a set of values representative of a set of characteristics associated with the video data.

### CROSS-REFERENCE TO RELATED APPLICATIONS

This application claims priority benefit of U.S. Provisional Application No. 62/268,279, filed Dec. 16, 2015, which is incorporated herein by reference in its entirety for all purposes.

### FIELD

The present disclosure generally relates to video analysis and, more particularly, to a model architecture of neural networks for analyzing and categorizing video data.

### BACKGROUND

Artificial neural networks (ANNs) are used in various applications to estimate or approximate functions dependent on a set of inputs. For example, ANNs may be used in speech recognition and to analyze images and video. Generally, ANNs are composed of a set of interconnected processing elements or nodes which process information by its dynamic state response to external inputs. Each ANN may include an input layer, one or more hidden layers, and an output layer. The one or more hidden layers are made up of interconnected nodes that process input via a system of weighted connections. Some ANNs are capable of updating by modifying their weights according to their outputs, while other ANNs are “feedforward” in which the information does not form a cycle.

There are many types of ANNs, where each ANN may be tailored to a different application, such as computer vision, speech recognition, image analysis, and others. Accordingly, there are opportunities to implement different ANN architectures to improve data analysis.

### SUMMARY

In an embodiment, a computer-implemented method of analyzing video data is provided. The method may include accessing an image tensor corresponding to an image frame of the video data, the image frame corresponding to a specific time, analyzing, by a computer processor, the image tensor using a convolutional neural network (CNN) to generate a first output vector, and accessing a second output vector output by a recurrent neural network (RNN) at a time previous to the specific time. In some embodiments, the method further includes processing the first output vector with the second output vector to generate a processed vector. In some embodiments, the first output vector and the second output vector are analyzed using the RNN to generate a third output vector, and analyzing, by the computer processor, the third output vector using a fully connected neural network to generate a prediction vector, the prediction vector comprising a set of values representative of a set of characteristics associated with the image frame. In alternative embodiments, the processed vector and second output vector are analyzed using the RNN to generate the third output vector.

In another embodiment, a system for analyzing video data is provided. The system may include a computer processor, a memory storing sets of configuration data respectively associated with a CNN, an RNN, and a fully connected neural network, and a neural network analysis module executed by the computer processor. The neural network analysis module may be configured to access an image tensor corresponding to an image frame of the video data, the image frame corresponding to a specific time, analyze the image tensor using the set of configuration data associated with the CNN to generate a first output vector, access a second output vector output by the RNN at a time previous to the specific time, analyze the first output vector and the second output vector using the set of configuration data associated with the RNN to generate a third output vector, and analyze the third output vector using the set of configuration data associated with the fully connected neural network to generate a prediction vector, the prediction vector comprising a set of values representative of a set of characteristics associated with the image frame. In some embodiments, the method further includes processing the first output vector with the second output vector to generate a processed vector, and generating the third output vector comprises analyzing the processed vector with the second output vector.

In some embodiments, the method further includes forming a scene based at least in part on the prediction vector and at least one other prediction vector generated at a different time than the specific time, and categorizing the scene based at least in part on the set of characteristics associated with the image frame.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1A depicts an overview of a system capable of implementing the present embodiments, in accordance with some embodiments.

FIG. 1B depicts an exemplary neural network architecture, in accordance with some embodiments.

FIGS. 2A and 2B depict exemplary prediction vectors resulting from an exemplary neural network analysis, in accordance with some embodiments.

FIG. 3 depicts a flow diagram associated with analyzing video data, in accordance with some embodiments.

FIG. 4 depicts a hardware diagram of an analysis machine and components thereof, in accordance with some embodiments.

### DETAILED DESCRIPTION

According to the present embodiments, systems and methods for analyzing and characterizing digital video data are disclosed. Generally, video data may be composed of a set of image frames each including digital image data, and optionally supplemented with audio data that may be synchronized with the set of image frames. The systems and methods employ an architecture composed of various types of ANNs. In particular, the architecture may include a convolutional neural network (CNN), a recurrent neural network (RNN), and at least one fully connected neural network, where the ANNs may analyze the set of image frames and optionally the corresponding audio data to determine or predict a set of events or characteristics that may be depicted or otherwise included in the respective image frames.

Prior to the architecture processing the video data, each of the ANNs may be trained with training data relevant to the desired context or application, using various backpropagation or other training techniques. In particular, a set of training image frames and/or training audio data, along with corresponding training labels, may be input into the corresponding ANN, which may analyze the inputted data to arrive at a prediction. By recursively arriving at predictions, comparing the predictions to the training labels, and minimizing the error between the predictions and the training labels, the corresponding ANN may train itself according to the input parameters. According to embodiments, the trained ANN may be configured with a set of corresponding edge weights which enable the trained ANN to analyze new video data.

Although the present embodiments discuss the analysis of video data depicting sporting events, it should be appreciated that the described architectures may be used to process video of other events or contexts. For example, the described architectures may process videos of certain activities depicting humans such as concerts, theatre productions, security camera footage, cooking shows, speeches or press conferences, and/or others. For further example, the described architectures may process videos depicting certain activities not depicting humans such as scientific experiments, weather footage, and/or others.

The systems and methods offer numerous benefits and improvements. In particular, the systems and methods offer an effective and efficient technique for identifying events and characteristics depicted in or associated with video data. In this regard, media distribution services may automatically characterize certain clips contained in videos and strategically feature those clips (or compilations of the clips) according to various campaigns and desired results. Further, individuals who view the videos may be presented with videos that may be more appealing to the individuals, thus improving user engagement. It should be appreciated that additional benefits of the systems and methods are envisioned.

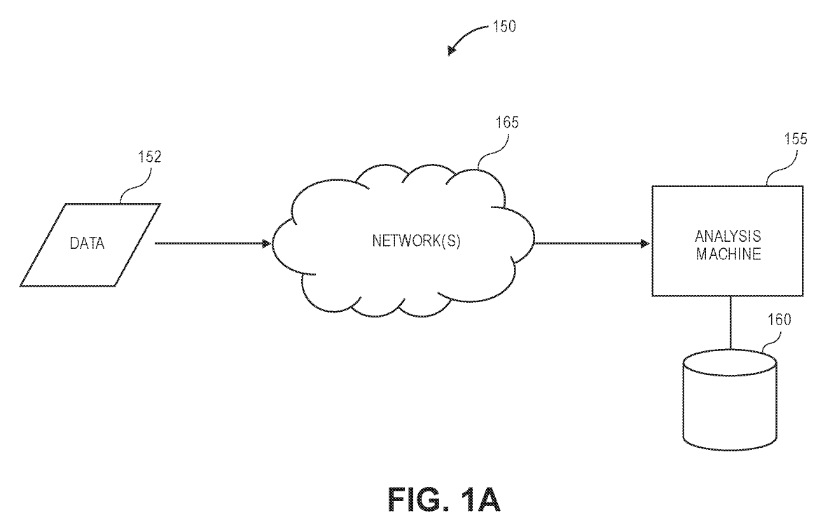

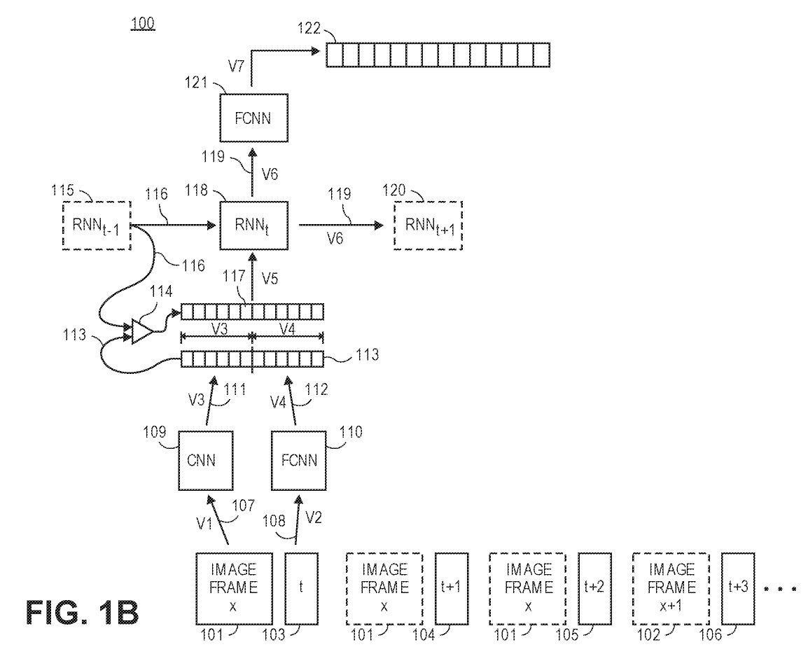

FIG. 1A depicts an overview of a system 150 for analyzing and characterizing video data. The system 150 may include an analysis machine 155 configured with any combination of hardware, software, and storage elements, and configured to facilitate the embodiments discussed herein. The analysis machine 155 may receive a set of data 152 via one or more communication networks 165. The one or more communication networks 165 may support any type of data communication via any standard or technology (e.g., GSM, CDMA, TDMA, WCDMA, LTE, EDGE, OFDM, GPRS, EV-DO, UWB, IEEE 802 including Ethernet, WiMAX, Wi-Fi, Bluetooth, Internet, and/or others).

The set of data 152 may be various types of real-time or stored media data, including digital video data (which may be composed of a sequence of image frames), digitized analog video, image data, audio data, or other data. The set of data 152 may be generated by or may otherwise originate from various sources, including one or more devices equipped with at least one image sensor and/or at least one microphone. For example, one or more video cameras may capture video data depicting a soccer match. In one implementation, the sources may transmit the set of data 152 to the analysis machine 155 in real-time or near-real-time as the set of data 152 is generated. In another implementation, the sources may transmit the set of data 152 to the analysis machine 155 at a time subsequent to generating the set of data 152, such as in response to a request from the analysis machine 155.

The analysis machine 155 may interface with a database 160 or other type of storage. The database 160 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The analysis machine 155 may store the set of data 152 locally or may cause the database 160 to store the set of data 152.

According to embodiments, the database 160 may store configuration data associated with various ANNs. In particular, the database 160 may store sets of edge weights for the ANNs, such as in the form of matrices, XML files, user-defined binary files, and/or the like. The analysis server 155 may retrieve the configuration data from the database 160, and may use the configuration data to process the set of data 152 according to a defined architecture or model. Generally, the ANNs discussed herein may include varied amounts of layers (i.e., hidden layers), each with varied amounts of nodes.

FIG. 1B illustrates an architecture 100 of interconnected ANNs and analysis capabilities thereof. A device or machine, such as the analysis machine 155 as discussed with respect to FIG. 1A, may be configured to implement the architecture 100. According to embodiments, the architecture 100 of interconnected ANNs may be configured to analyze video data and generate a prediction vector indicative of events of interest or characteristics included in the video data. Generally, video data may include a set of image frames and corresponding audio data.

The image frames and the audio data may be synced so that the audio data matches the image frames. In such implementations, the audio data and the image frames may be of differing rates. In one example, the audio rate may be four times higher than the image frame rate, however such an example should not be considered limiting. As a result, there may be multiple audio data representations that correspond to the same image frame. FIG. 1A illustrates video data in the form of a set of image frames and audio data represented as individual spectrograms. In particular, the image frames include image frame (X) 101 and image frame (X+1) 102, and the audio data is represented by spectrogram (t) 103, spectrogram (t+1) 104, spectrogram (t+2) 105, and spectrogram (t+3) 106. Generally, a spectrogram is a visual representation of the spectrum of frequencies included in a sound, where the spectrogram may include multiple dimensions such as a first dimension that represents time, a second dimension that represents frequency, and a third dimension that represents the amplitude of a particular frequency (e.g., represented by intensity or color). For purposes of explanation and without implying limitation, a case may be considered in which, for the image frames to be in sync with the audio data, there are three spectrograms for each image frame. Accordingly, as illustrated in FIG. 1, there are three spectrograms 103, 104, 105 for image frame (X) 101. Similarly, image frame (X+1) 102 is matched with spectrogram (t+3) 106.

Each of the images frames 101, 102 and the spectrograms 103-106 may be represented as a tensor. As known to those of skill in the art, a tensor is a generic term for data arrays. For example, a one-dimensional tensor is commonly known as a vector, and a two-dimensional tensor is commonly known as a matrix. In the following description, the term ‘tensor’ may be used interchangeably with the terms ‘vector’ and ‘matrix’. Generally, a tensor for an image frame may include a set of values each representing the intensity of the corresponding pixel of the image frame, the pixels being represented as a two-dimensional matrix. Alternatively, the image frame tensor may be flattened into a one dimensional a vector. The image tensor may also have an associated depth that represents the color of the corresponding pixel. Similarly, a tensor for a spectrogram may include a set of values representative of the sound properties (e.g., high frequencies, low frequencies, etc.) included in the spectrogram. As illustrated in FIG. 1A, the image frame (X) 101 may be represented as a tensor (V1) 107 and the spectrogram (t) 103 may be represented as a tensor (V2) 108.

The tensor (V1) 107 may serve as the input tensor into a convolutional neural network (CNN) 109 and the tensor (V2) 108 may serve as the input tensor into a fully connected neural network (FCNN) 110. According to embodiments, the CNN 109 may be composed of multiple layers of small node collections which examine small portions of the input data (e.g., pixels of image tensor (V1) 107), where upper layers of the CNN 109 may tile the corresponding results so that they overlap to obtain a vector representation of the corresponding image (i.e., the image frame (X) 101). In processing the input tensor (V1) 107, the CNN 109 may generate a corresponding output vector (V3) 111 representative of the processing by the multiple layers of the CNN 109. In some embodiments, output vector (V3) 111 includes high-level information associated with static detected events in image frame 101. Such events may include, but are not limited to, the presence of a person, object, location, emotions on a person's face, among various other types of events. The static events included in vector (V3) 111 may include events that can be identified using a single image frame by itself, that is to say, events that are identified in the absence of any temporal context.

Similarly, the FCNN 110 may also include multiple layers of nodes, where the nodes of the multiple layers are all connected. In processing the input tensor (V2) 108, the FCNN 110 may generate a corresponding output vector (V4) 112 representative of the processing by the multiple layers of the FCNN 110. In some embodiments, the FCNN 110 serves a similar purpose to CNN 109 described above, however the output vector (V4) may include high-level information associated with audio events in a video's audio, the audio events identified by analyzing slices of a spectrogram described above. For example, crowd noise in an audio clip may have a certain spectral representation, which may be used to identify that an event is good or bad, depending on the audible reaction of a crowd. Such an event which may be used to determine what emotions may be evoked by a viewer. The output vector (V3) 111 and the output vector (V4) 112 may be appended to produce an appended vector 113 having a number of elements that may equal the sum of the number of elements in output vector (V3) 111 and the number of elements in output vector (V4) 112. For example, if each of the output vector (V3) 111 and the output vector (V4) 112 has 256 elements, the appended vector 113 may have 512 elements. In some implementations, the video data may not have corresponding audio data, in which case the FCNN 110 may not be needed. In such embodiments, output vector (V3) 111 may be directly input to module 114. In other such embodiments, output vector (V3) 111 may be directly input to RNN 118.

Generally, a recurrent neural network (RNN) is a type of neural network that performs a task for every element of a sequence, with the output being dependent on the previous computations, thus enabling the RNN to create an internal state to enable dynamic temporal behavior. The inputs to an RNN at a specific time are an input vector as well as an output of a previous state of the RNN (a condensed representation of the processing conducted by the RNN prior to the specific time). Accordingly, the previous state that serves as an input to the RNN may be different for each successive temporal analysis. The output of the RNN at the specific time may then serve as an input to the RNN at a successive time (in the form of the previous state).

In some embodiments, as illustrated an FIG. 1, the architecture 100 may include a module 114 or other logic configured to process the appended vector 113 and an output vector 116 of an RNN 115 at a previous time (t−1). In one implementation, the module 114 may multiply the elements of the appended vector 113 with the elements of the output vector 116, however it should be appreciated that the module 114 may process the appended vector 113 and the output vector 116 according to different techniques. In some embodiments, module 114 is an attention module that assists the system in processing and/or focusing on certain types of detected image/audio events when there are potentially many image and audio event types present. Accordingly, the output of the module 114 may be in the form of a vector (V5) 117, where the vector (V5) 117 may have the same or different number of elements as the appended vector 113. In some embodiments, module 114 is not used, and output vector (V3) 111 may be directly forwarded to RNN 118 for processing with vector 116. In some embodiments including audio processing, appended vector (V5) 117 is forwarded to RNN 118 for processing with vector 116.

At the current time (t), the RNN 118 may receive, as inputs, output vector (V3) 111 and an output vector 116 of the RNN 115 generated at the previous time (t−1). In some embodiments, RNN 118 may receive appended vector 113 or the processed vector (V5) 117, as described above. The RNN 118 may accordingly analyze the inputs and output a vector (V6) 119 which may serve as an input to the RNN 120 at a subsequent time (t+1) (i.e., the vector (V6) 119 is the previous state for the RNN 120 at the subsequent time (t+1)). In some embodiments, the output vector (V6) 119 includes information about high-level image and audio events that includes events detected in a temporal context. For example, if the vector 116 of the previous frame includes information that a player may be running in a football game (through analysis of body motion, etc.), the RNN 118 may analyze several consecutive frames to identify if the player is running during a play, or if the player is simply running off the field for a substitution. Other temporal events may be analyzed as well, and the previous example should not be considered limiting. The architecture 100 may also include an additional FCNN 121 that may receive, as an input, the vector (V6) 119. The FCNN 121 may analyze the vector (V6) 119 and output a prediction vector (V7) 122 that may represent various contents and characteristics of the original video data.

According to embodiments, the prediction vector (V7) 122 may include a set of values (e.g., in the form of real numbers, Boolean, integers, etc.), each of which may be representative of a presence of a certain event or characteristic that may be depicted in the original video data at that point in time (i.e., time (t)). The events or characteristics may be designated during an initialization and/or training of the FCNN 121. Further, the events or characteristics themselves may correspond to a type of event that may be depicted in the original video, an estimated emotion that may be evoked in a viewer of the original video or evoked in an individual depicted in the original video, or another event or characteristic of the video. For example, if the original video depicts a football game, the events may be a run play, a pass play, a first down, a field goal, a start of a play, an end of a play, a punt, a touchdown, a safety, or other events that may occur during the football game. For further example, the emotions may be happiness, anger, surprise, sadness, fear, or disgust

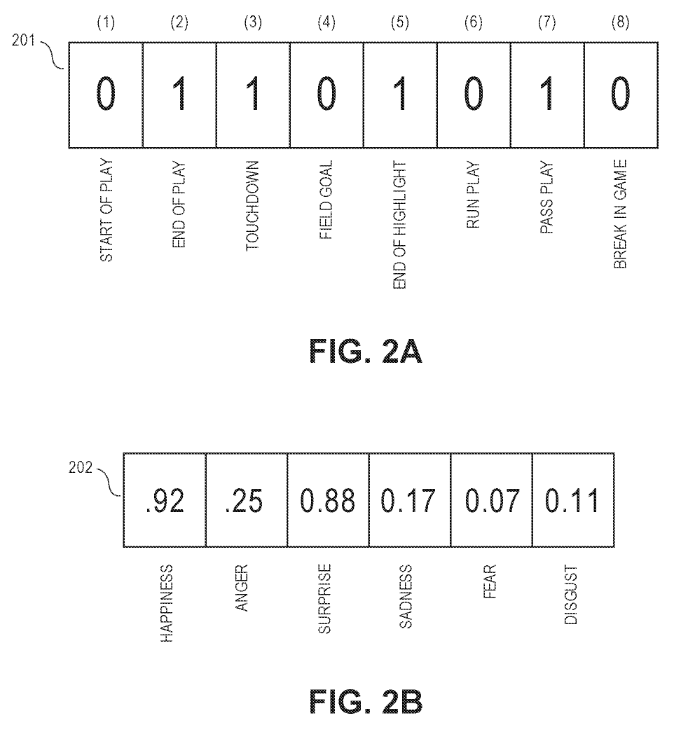

FIGS. 2A and 2B depict example prediction vectors that each include a set of values representative of a set of example events or characteristics that may be depicted in the subject video data. In particular, FIG. 2A depicts a prediction vector 201 associated with a set of eight (8) events that may be depicted in a specific image frame (and corresponding audio data) of a video of a football game. In particular, as shown in FIG. 2A, the events include: start of a play, end of play, touchdown, field goal, end of highlight, run play, pass play, and break in game. The values of the prediction vector 201 may be Boolean values (i.e., a “0” or a “1”), where a Boolean value of “0” indicates that the corresponding event was not detected in the specific image frame and a Boolean value of “1” indicates that the corresponding event was detected in the specific image frame. Accordingly, for the prediction vector 201, the applicable neural network detected that the specific image frame depicts an end of play, a touchdown, an end of highlight, and a pass play.

Similarly, FIG. 2B depicts a prediction vector 202 associated with a set of emotions that may be evoked in an individual watching a specific image frame of a video of an event (e.g., a football game). In some embodiments, as shown in FIG. 2B, the emotions include: happiness, anger, surprise, sadness, fear, and disgust. The values of the prediction vector 202 may be real numbers between 0 and 1. In an exemplary implementation, if a given element for a given emotion exceeds a threshold value (e.g., 0.7), then the system may deem that the given emotion is evoked, or at least deem that the probability of the given emotion being evoked is higher. Accordingly, for the prediction vector 202, the system may deem that the emotions being evoked by an individual watching the specific image frame are happiness and surprise. It should be appreciated that the threshold values may vary among the emotions, and may be configurable by an individual.

Generally, the values of the prediction vectors may be assessed according to various techniques. For example, in addition to the Boolean values and values meeting or exceeding threshold values, the values may be a range of numbers (e.g., integers between 1-10), where the higher (or lower) the number, the higher (or lower) the probability of an element or characteristic being depicted in the corresponding image frame. It should be appreciated that additional value types and processing thereof are envisioned.

In some embodiments, one or more prediction vectors may be provided to a scene-development system for analysis and scene development. In some embodiments, the prediction vectors may be collectively used to form video scenes, such as a passing touchdown play in a football game. In such an example, the system may set a start frame of the scene according to a prediction vector indicating a play has started, and set and end frame of the scene according to a prediction vector indicating a play has ended. The scene may include all intermediate frames in between the start and end frame, each intermediate frame being associated with an intermediate prediction vector. Intermediate prediction vectors generated by the intermediate frames may indicate that a passing play occurred, a running play occurred, a touchdown occurred, etc. In some embodiments, the values contained in the prediction vectors are used to characterize scenes according to various event types, emotions, and various other characteristics. Thus, a user may select to view a scene or a group of scenes as narrow as passing touchdown plays of forty yards or more for a particular team. Alternatively, a user may select to view a group of scenes as broad as important plays in a football game that invoke large reactions from the crowd, regardless of which team the viewer may be rooting for.

In some embodiments, the prediction vector used in part for forming a scene using at least one other prediction vector processed at a different time than the specific time, and for categorizing the scene based at least in part on the set of characteristics associated with the image frame. For example, in some embodiments, a stream of output prediction vectors is applied to the corresponding video to segment the video into a plurality of scenes.

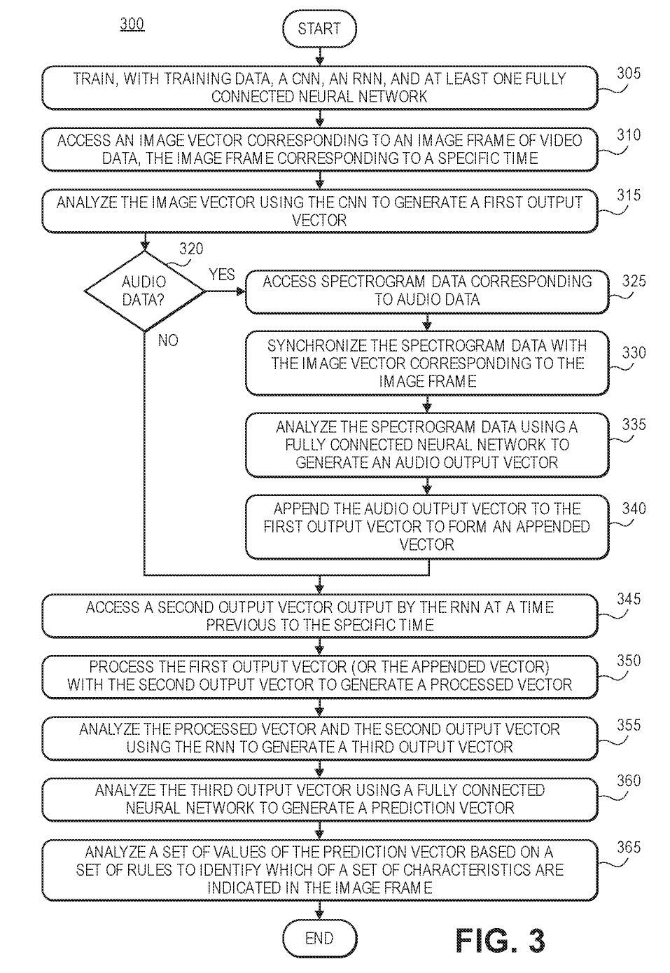

FIG. 3 illustrates a flow diagram of a method 300 of analyzing video data. The method 300 may be facilitated by any electronic device including any combination of hardware and software, such as the analysis machine 155 as described with respect to FIG. 1A.

The method 300 may begin with the electronic device training (block 305), with training data, a CNN, an RNN, and at least one fully connected neural network. According to embodiments, the training data may be of a particular format (e.g., audio data, video data) with a set of labels that the corresponding ANN may use to train for intended analyses using a backpropagation technique. The electronic device may access (block 310) an image tensor corresponding to an image frame of video data, where the image frame corresponds to a specific time. The electronic device may access the image tensor from local storage or may dynamically calculate the image tensor based on the image frame as the image frame is received or accessed. The electronic device may analyze (block 315) the image tensor using the CNN to generate a first output vector.

In some implementations, the video data may have corresponding audio data representative of sound captured in association with the video data. The electronic device may determine (block 320) whether there is corresponding audio data. If there is not corresponding audio data (“NO”), processing may proceed to block 345. If there is corresponding audio data (“YES”), the electronic device may access (block 325) spectrogram data corresponding to the audio data. In embodiments, the spectrogram data may be representative of the audio data captured at the specific time, and may represent the various frequencies included in the audio data. The electronic device may also synchronize (block 330) the spectrogram data with the image tensor corresponding to the image frame. In particular, the electronic device may determine that a frequency associated with the audio data differs from a frequency associated with the video data, and that each image frame should be processed in association with multiple associated spectrogram data objects. Accordingly, the electronic device may reuse the image tensor that was previously analyzed with previous spectrogram data.

The electronic device may also analyze (block 335) the spectrogram data using a fully connected neural network to generate an audio output vector. Further, the electronic device may append (block 340) the audio output vector to the first output vector to form an appended vector. Effectively, the appended vector may be a combination of the audio output vector and the first output vector. It should be appreciated that the electronic device may generate the appended vector according to alternative techniques.

In some embodiments, at block 345, the electronic device may access a second output vector output by the RNN at a time previous to the specific time. In this regard, the second output vector may represent a previous state of the RNN. In some embodiments, the electronic device processes (block 350) the first output vector (or, if there is also audio data, the appended vector) with the second output vector to generate a processed vector. In an implementation, the electronic device may multiply with the first output vector (or the appended vector) with the second output vector. It should be appreciated that alternative techniques for processing the vectors are appreciated.

The electronic device may analyze (block 355) the first output vector (or alternatively, the appended vector or the processed vector in some embodiments) and the second output vector using the RNN to generate a third output vector. Effectively, the first vector and the second output vector (i.e., the previous state) are inputs to the RNN and the third output vector, which includes high-level information associated with static and temporally detected events, is the output of the RNN. The electronic device may analyze (block 360) the third output vector using a fully connected neural network to generate a prediction vector. In embodiments, the fully connected neural network may be different than the fully connected neural network that the electronic device used to analyze the spectrogram data.

Further, in embodiments, the prediction vector may comprise a set of values representative of a set of characteristics associated with the image frame, where the set of values may be various types including Boolean values, integers, real numbers, or the like. Accordingly, the electronic device may analyze (block 365) the set of values of the prediction vector based on a set of rules to identify which of the set of characteristics are indicated in the image frame. In embodiments, the set of rules may have associated threshold values where when any value meets or exceeds a threshold value, the corresponding characteristic may be deemed to be indicated in the image frame.

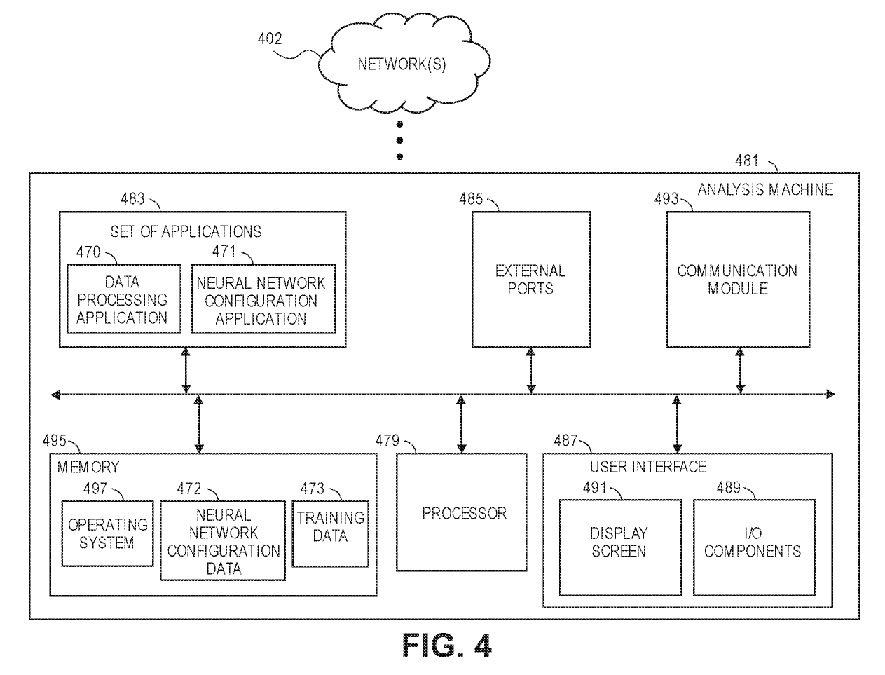

FIG. 4 illustrates an example analysis machine 481 in which the functionalities as discussed herein may be implemented. In some embodiments, the analysis machine 481 may be the analysis machine 155 as discussed with respect to FIG. 1A. Generally, the analysis machine 481 may be a dedicated computer machine, workstation, or the like, including any combination of hardware and software components.

The analysis machine 481 may include a processor 479 or other similar type of controller module or microcontroller, as well as a memory 495. The memory 495 may store an operating system 497 capable of facilitating the functionalities as discussed herein. The processor 479 may interface with the memory 495 to execute the operating system 497 and a set of applications 483. The set of applications 483 (which the memory 495 can also store) may include a data processing application 470 that may be configured to process video data according to one or more neural network architectures, and a neural network configuration application 471 that may be configured to train one or more neural networks.

The memory 495 may also store a set of neural network configuration data 472 as well as training data 473. In embodiments, the neural network configuration data 472 may include a set of weights corresponding to various ANNs, which may be stored in the form of matrices, XML files, user-defined binary files, and/or other types of files. In operation, the data processing application 470 may retrieve the neural network configuration data 472 to process the video data. Further, the neural network configuration application 471 may use the training data 473 to train the various ANNs. It should be appreciated that the set of applications 483 may include one or more other applications.

Generally, the memory 495 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The analysis machine 481 may further include a communication module 493 configured to interface with one or more external ports 485 to communicate data via one or more communication networks 402. For example, the communication module 493 may leverage the external ports 485 to establish a wide area network (WAN) or a local area network (LAN) for connecting the analysis machine 481 to other components such as devices capable of capturing and/or storing media data. According to some embodiments, the communication module 493 may include one or more transceivers functioning in accordance with IEEE standards, 3GPP standards, or other standards, and configured to receive and transmit data via the one or more external ports 485. More particularly, the communication module 493 may include one or more wireless or wired WAN and/or LAN transceivers configured to connect the analysis machine 481 to WANs and/or LANs.

The analysis machine 481 may further include a user interface 487 configured to present information to the user and/or receive inputs from the user. As illustrated in FIG. 4, the user interface 487 may include a display screen 491 and I/O components 489 (e.g., capacitive or resistive touch sensitive input panels, keys, buttons, lights, LEDs, cursor control devices, haptic devices, and others). According to embodiments, a user may input the training data 473 via the user interface 487.

In general, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 479 (e.g., working in connection with the operating system 497) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML, and/or others).

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

What is claimed is:

1. A computer-implemented method of analyzing video data, the method comprising:
accessing an image tensor corresponding to an image frame of the video data, the image frame corresponding to a specific time;
analyzing, by a computer processor, the image tensor using a convolutional neural network (CNN) to generate a first output vector, the first output vector including high-level image event information associated with static detected events;
accessing a second output vector output by a recurrent neural network (RNN) at a time previous to the specific time;
analyzing, by the computer processor, the first output vector and the second output vector using the RNN to generate a third output vector, the third output vector including high-level image event information associated with static and temporally detected events;
analyzing, by the computer processor, the third output vector using a fully connected neural network to generate a prediction vector, the prediction vector comprising a set of values representative of a set of characteristics associated with the image frame.

2. The computer-implemented method of claim 1, further comprising:
accessing spectrogram data corresponding to audio data recorded at the specific time; and
analyzing, by the computer processor, the spectrogram data using a second fully connected neural network to generate an audio output vector.

3. The computer-implemented method of claim 2, further comprising:
appending the audio output vector to the first output vector to form an appended vector;
wherein analyzing the first output vector and the second output vector comprises:
analyzing the appended vector and the second output vector to generate the third output vector.

4. The computer-implemented method of claim 2, further comprising:
synchronizing the spectrogram data with the image tensor corresponding to the image frame.

5. The computer-implemented method of claim 4, wherein synchronizing the spectrogram data with the image tensor comprises:
determining that a frequency associated with the audio data differs from a frequency associated with the video data; and
reusing the image tensor that was previously analyzed with previous spectrogram data.

6. The computer-implemented method of claim 1, wherein analyzing the first output vector and the second output vector comprises:
processing the first output vector with the second output vector to generate a processed vector, and analyzing the processed vector with the second output vector to generate the third output vector.

7. The computer-implemented method of claim 1, further comprising:
analyzing, by the computer processor, at least the third output vector by the recurrent neural network (RNN) at a time subsequent to the specific time.

8. The computer-implemented method of claim 1, further comprising:
analyzing the set of values of the prediction vector based on a set of rules to identify which of the set of characteristics are indicated in the image frame.

9. The computer-implemented method of claim 1, further comprising:
training, with training data, the convolutional neural network (CNN), the recurrent neural network (RNN), and the fully connected neural network.

10. The computer-implemented method of claim 9, further comprising:
storing, in memory, configuration data associated with training the convolutional neural network (CNN), the recurrent neural network (RNN), and the fully connected neural network.

11. A system for analyzing video data, comprising:
a computer processor;
a memory storing sets of configuration data respectively associated with a convolutional neural network (CNN), a recurrent neural network (RNN), and a fully connected neural network; and
a neural network analysis module executed by the computer processor and configured to:
access an image tensor corresponding to an image frame of the video data, the image frame corresponding to a specific time,
analyze the image tensor using the set of configuration data associated with the CNN to generate a first output vector, the first output vector including high-level image event information associated with static detected events,
access a second output vector output by the RNN at a time previous to the specific time,
analyze the first output vector and the second output vector using the set of configuration data associated with the RNN to generate a third output vector, and
analyze the third output vector using the set of configuration data associated with the fully connected neural network to generate a prediction vector, the prediction vector comprising a set of values representative of a set of characteristics associated with the image frame.

12. The system of claim 11, wherein the memory further stores a set of configuration data associated with a second fully connected neural network, and wherein the neural network analysis module is further configured to:
access spectrogram data corresponding to audio data recorded at the specific time, and
analyze the spectrogram data using the set of configuration data associated with the second fully connected neural network to generate an audio output vector.

13. The system of claim 12, wherein the neural network analysis module is further configured to:
append the audio output vector to the first output vector to form an appended vector;
and wherein to analyze the first output vector and the second output vector, the neural network analysis module is configured to:
analyze the appended vector and the second output vector to generate the third vector.

14. The system of claim 12, wherein the neural network analysis module is further configured to:
synchronize the spectrogram data with the image tensor corresponding to the image frame.

15. The system of claim 14, wherein to synchronize the spectrogram data with the image tensor, the neural network analysis module is configured to:
determine that a frequency associated with the audio data differs from a frequency associated with the video data, and
reuse the image tensor that was previously analyzed with previous spectrogram data.

16. The system of claim 11, wherein to analyze the first output vector and the second output vector, the neural network analysis module is configured to:
process the first output vector with the second output vector to generate a processed vector, and to analyze the processed vector with the second output vector to generate the third output vector.

17. The system of claim 11, wherein the neural network analysis module is further configured to:
analyze at least the third output vector using the set of configuration data associated with the recurrent neural network (RNN) at a time subsequent to the specific time.

18. The system of claim 11, wherein the neural network analysis module is further configured to:
analyze the set of values of the prediction vector based on a set of rules to identify which of the set of characteristics are indicated in the image frame.

19. The system of claim 11, wherein the neural network analysis module is further configured to:
train, with training data, the convolutional neural network (CNN), the recurrent neural network (RNN), and the fully connected neural network.

20. The system of claim 19, wherein the neural network analysis module is further configured to:
store, in the memory, the sets of configuration data associated with training the convolutional neural network (CNN), the recurrent neural network (RNN), and the fully connected neural network.
